(19) United States
(12) Patent Application Publication
(10) Pub. No.: US 2020/0356812 A1
(43) Pub. Date: Nov. 12, 2020

(54) SYSTEMS AND METHODS FOR AUTOMATED TRAINING OF DEEP-LEARNING-BASED OBJECT DETECTION

(71) Applicant: MOLEY SERVICES UK LIMITED, London (GB)

(72) Inventors: Mark Oleynik, Monaco (MC); Alexey Chaykin, Nizhny Novgorod (RU)

(21) Appl. No.: 16/870,899

(22) Filed: May 9, 2020

Related U.S. Application Data
(60) Provisional application No. 62/845,900, filed on May 10, 2019.

(51) Int. Cl. G06K 9/62; G06K 9/34; H04N 13/243; G06K 9/20; H04N 13/246; H04N 5/232; G06N 3/08

(52) U.S. Cl. CPC G06K 9/6256; G06K 9/6262; G06K 9/34; G06N 3/08; G06K 9/209; H04N 13/246; H04N 5/23299; H04N 13/243

(57) ABSTRACT

The present disclosure is directed to a method and a system which trains object detection neural networks with a dependency based loss function for capturing dependent training images. The object detection neural networks system comprises a calibrated camera system for capturing images for the object detection neural network model and the dependent based loss function to process dependent training images, which is then fed to an optimizer to adjust parameters of the object detection neural network model to minimize the loss value. Additional penalties can be imposed by knowledge base rules. A camera system in the object detection neural networks system can include cameras with a fixed distance between neighboring cameras, or unaligned cameras arranged at various distances and/or angles between them, with an option to add sensors to the camera system.

### CROSS REFERENCE TO RELATED APPLICATIONS

This application claims priority to U.S. Provisional Application Ser. No. 62/845,900 entitled “System for Automated Training of Deep-Learning-Based Robotic Perception System,” filed 10 May 2019, the disclosure of which is incorporated herein by reference in its entirety.

### BACKGROUND

### Technical Field

The present disclosure generally relates to artificial intelligence (AI), more particularly to automated training of object detection neural networks by the use of dependency based loss function and a calibrated camera system to produce dependent images.

### Background Art

Deep Neural Networks (DNNs) have become the most widely used approach in the domain of Artificial Intelligence (AI) for extracting high-level information from low-level data such as an image, a video, etc. Conventional solutions require a large amount of annotated training data which deters the use of DNNs in many applications.

Object detection neural networks require thousands of annotated object images, captured at all possible lighting conditions, angles, distances and backgrounds to be successfully trained to detect and identify this kind of objects. Annotated means that each of the training images should be accompanied with accurate bounding box coordinates and class identifier label for each of the depicted objects, which makes creation of the DNN based vision system quite expensive and time consuming.

Accordingly, it is desirable to have systems and methods that reduce the amount of manual annotation efforts required to train accurate and reliable DNN.

### SUMMARY OF THE INVENTION

Embodiments of the present disclosure are directed to a method and a system which trains object detection neural networks without requiring to annotate big amounts of training data, which was made possible by the introduction of Dependency Based Loss Function and a system for capturing Dependent Training Images. The system for automated training of object detection neural networks comprises a calibrated camera system for capturing dependent training images, object detection neural network model with a list of adjustable parameters and the dependency based loss function to measure the network model's predictive capability related to a given set of parameters, which is then fed to an optimizer to adjust parameters of the object detection neural network model to minimize the loss value.

In a first embodiment, the system for automated training of object detection neural networks includes a camera system with two or more aligned overhead cameras (preferably the same model and type) disposed on a same axis and having a fixed distance between neighboring cameras, resulting in a fixed offset between object bounding boxes related to images from neighboring cameras, thereby enabling the computation of dependency based bounding box loss as a discrepancy between modelled offset value (also referred to as “expected offset value”) and offset between predicted object bounding boxes associated with neighboring cameras.

In a second embodiment, the system for automated training of object detection neural networks includes a camera system with three or more unaligned cameras arranged at various distances and/or angles between them. Given that all of the cameras are observing the same object at a time, physical object coordinates within each set of simultaneously captured images are also the same, which enables to compute dependency based loss as a discrepancy between physical object coordinates, computed by stereo pairs, first stereo pair organized between first and second cameras, second stereo pair organized between first and third camera and etc. (e.g., the first camera is common for all stereo pairs).

In a third embodiment, the system for automated training of object detection neural networks comprises an instrumented environment for observing one or more objects in natural surrounding, where objects are moving with known velocity along the known trajectories, thereby enabling the computation of dependency based loss as a discrepancy between modelled offset value and offset between predicted object bounding boxes associated with images sequentially captured by the same camera. In a fourth embodiment, the system for automated training of object detection neural networks comprises a plurality of sensors and knowledge base, which provides additional limitations on predicted object bonding boxes, class identifiers and extends dependency based loss function.

Broadly stated, a method for automated training of deep learning based object detection system comprises (a) capturing two or more images of an object from a plurality of angles by a calibrated camera system, the two or more cameras having a predetermined position between each camera and the object; (b) generating a modelled bounding box offset and dimensions, the modelled bounding box having an approximate offset between two bounding boxes of the same object on images from two different cameras; (c) propagating the two or more images through a neural network model, thereby producing a predicted object bounding box and class identifier for each captured image, and generating a predicted bounding box offset between bounding boxes from images of neighboring cameras; (d) computing a loss value as a sum of a first penalty value computed as the discrepancy between the modelled bounding box offset and a predicted bounding box offset and a second penalty value computed as the discrepancy between the modelled bounding box dimensions and dimensions of predicted bounding boxes from the same image in the two or more images captured by the camera system; and (e) adjusting the plurality of neural network parameters Wi until the loss function is minimized to less than a predetermined threshold, based on an optimization algorithm and steps (c) and (d) for the loss computation with selected neural network parameters values.

The structures and methods of the present invention are disclosed in the detailed description below. This summary does not purport to define the invention. The invention is defined by the claims. These and other embodiments, features, aspects, and advantages of the invention will become better understood with regard to the following description, appended claims, and accompanying drawings.

### BRIEF DESCRIPTION OF THE DRAWINGS

The invention will be described with respect to specific embodiments thereof, and reference will be made to the drawings, in which:

FIG. 1 is a block diagram illustrating a first embodiment of a system for automated training of object detection neural networks in accordance with the present invention.

FIG. 2 is a graphical diagram illustrating the modelled object bounding box offset computation for the case of aligned, equidistant camera planes in accordance with the present invention.

FIG. 3 is a software system diagram illustrating a plurality of modules in the system for automated training of object detection neural networks in accordance with the present invention.

FIG. 4A is a flow diagram illustrating the process of functional steps of the system for automated training of object detection neural networks in accordance with the present invention; and FIG. 4B is a flow diagram illustrating the step 100 as shown in FIG. 4A for some embodiments, where the optimizer is configured to compute intermediate loss values for one or more temporary sets of modified parameters in accordance with the present invention.

FIG. 5A is a system diagram illustrating a second embodiment of the system for automated training of object detection neural networks with a highlighted first stereo pair, that comprises the first camera and the second camera in accordance with the present invention; and FIG. 5B is a system diagram illustrating a second embodiment of the system for automated training of object detection neural networks with highlighted second stereo pair, that comprises the first camera and the third camera in accordance with the present invention.

FIG. 6 is a software system diagram illustrating a second embodiment of the system for automated training of object detection neural networks with a plurality of stereo depth modules, configured to compute physical object coordinates from bounding box predictions in accordance with the present invention.

FIG. 7 is a block diagram illustrating a third embodiment of the system for automated training of object detection neural networks in accordance with the present invention.

FIGS. 8A and 8B are graphical diagrams illustrating the computation of modelled bounding box offset for the case of static camera and object moving along it's x-axis with constant velocity , in accordance with the present invention.

FIG. 9 is a block diagram illustrating a fourth embodiment of the system for automated training of object detection neural networks with one or more sensors and knowledge base rules in accordance with the present invention.

FIG. 10 is a flow diagram illustrating the fourth embodiment of the system for automated training of object detection neural networks with one or more sensors and knowledge base rules in accordance with the present invention.

FIG. 11A is a block diagram illustrating a fifth embodiment of a system for automated training of object detection neural networks in accordance with the present invention; and FIG. 11B is a flow diagram illustrating a fifth embodiment of the process of functional steps of the system for automated training of object detection neural networks in accordance with the present invention.

FIG. 12A is a block diagram illustrating an example of a central processing unit (CPU) and a graphics processing unit (GPU) in operation with the cameras and sensors in accordance with the present invention; and FIG. 12B is a block diagram illustrating an example of a computer device on which computer-executable instructions to perform the robotic methodologies discussed herein may be installed and executed.

### DETAILED DESCRIPTION

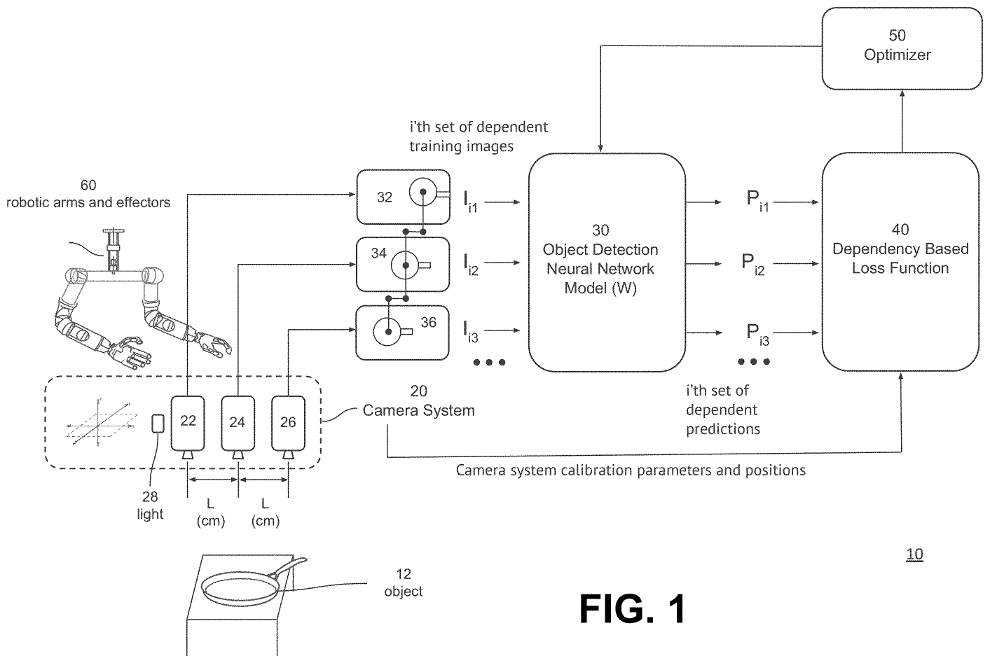

A description of structural embodiments and methods of the present invention is provided with reference to FIGS. 1-12. It is to be understood that there is no intention to limit the invention to the specifically disclosed embodiments but that the invention may be practiced using other features, elements, methods, and embodiments. Like elements in various embodiments are commonly referred to with like reference numerals.

The following definitions apply to the elements and steps described herein. These terms may likewise be expanded upon.

Bounding Box—refers to the coordinates and size of the rectangular border that fully encloses the on-image area, occupied by the object. The term “bounding box” referring to any geometric shapes is also applicable.

Class Identifier (or Class ID)—refers to a numeric identifier, specifying the type of the object according to some classification, e.g. a pot, a pan, a steak, a car, a dog, a cat and etc.

Dependency Based Loss Function—refers to estimating object detection DNN's performance, by measuring how well predictions, produced by the object detection DNN from dependent training images, fits the dependency rule. In one embodiment, unlike a conventional loss function that measures the discrepancy between predicted bounding boxes and ground truth annotations, the dependency-based loss function does not require ground-truth bounding boxes to be provided for every training image and thus enables to train object detection neural networks in an automated way.

Dependent Training Images—refers to images captured in the way that the same object(s) is depicted on each of them and respective bounding boxes are bound together by some known rule (i.e. dependency rule), resulting from camera system configuration and object position and orientation with respect to each of the cameras.

Forward Pass (or inference)—refers to propagating through the DNN, i.e. iteratively performing DNN's computations layer by layer, from given input value to resulting output (for example, in case of object detection DNN, from input image to higher and higher level features and finally to a list of bounding boxes and class identifiers).

Loss Function—refers to a function that measures how well a DNN performs, for example by computation of discrepancy between a predictions produced by the DNN for each of the training samples with respective ground truth answers (or annotations), e.g. during the training of an object detection neural network convenient loss function compares predicted bounding boxes and class identifiers with those, provided in ground truth annotation of respective image.

Loss Value—refers to the result of Loss Function or Dependency Based Loss Function, computed for a certain set of predictions, produced by the DNN for a certain set of training samples.

Modelled Bounding Box Dimensions (also referred to as Expected Bounding Box Dimensions)—refers to an approximate size of object's projection to the camera plane, computed from the optical model of the camera system (in some embodiments, by image analysis, based on background subtraction and color segmentation).

Modelled Bounding Box Offset (also referred to as Expected Bounding Box Offset)—refers to an approximate offset, for example, between two bounding boxes of the same object on images from two different cameras (i.e. an approximate offset between projections of the same object to two camera planes), computed from the optical model of the camera system.

Object Detection Neural Network (also referred to as Object Detection Deep Neural Network, or Object Detection DNN)—refers to DNN, configured to extract bounding boxes and class identifiers from images.

Predicted Bounding Box Offset—refers to an offset between bounding boxes predicted by the object detection DNN for two images, depicting the same object.

Training of a Deep Neural Network—refers to computation by iterative adjustment of its parameters, minimizing the output of Loss Function, computed over huge amounts of training data.

FIG. 1 is a block diagram illustrating a first embodiment of a system for automated training of object detection neural networks 10 in accordance with the present invention. The system for automated training of object detection neural networks comprises a camera system 20, an object detection neural network model 30, a dependency based loss function 40, an optimizer 50.

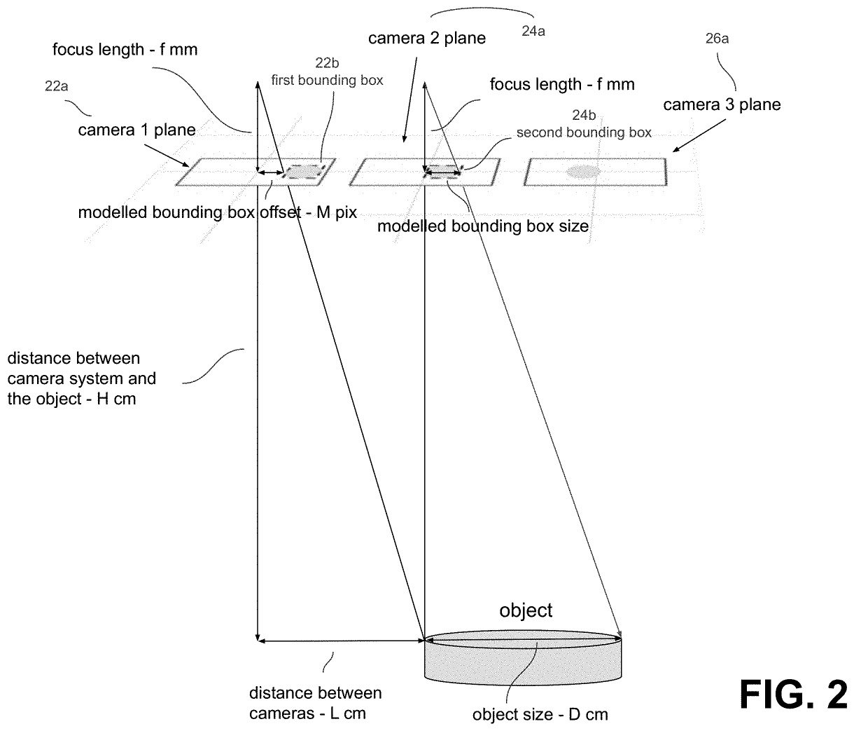

The camera system 20 comprises two or more aligned overhead cameras 22, 24, 26, of a same model and type disposed on a same axis and having a fixed distance of L between neighboring cameras, which results in a fixed X offset of M pixels between object bounding boxes related to images from neighboring cameras, as also illustrated in FIG. 2. To phrase it another way, the camera system 20 is configured to produce dependent images of the same object 12. The distance measurement in the fixed distance L between the neighboring cameras 22, 24, 26, can be made in any metric length units, such as in centimeters (cm), inches, etc.

The camera system 20 is able to move in x-axis, y-axis, and/or z-axis directions to observe and image the object 12 from different angles and distances. The camera system 20 is calibrated, i.e., equipped with one or more calibration parameters, including but not limited to, focal length, principal point, distortion coefficients, rotation and translation matrices, which are computed or obtained for each of the cameras 22, 24, 26, which enables to compute modelled bounding box offset M for each camera system's position, as shown in FIG. 2, using the formula:

M=(L*f)/(H*S)

where the symbol L denotes a distance (in centimeters) between neighboring cameras, the symbol H denotes a distance between the camera system 20 and the object 12 (in centimeters), the symbol fdenotes a camera focus length in millimeters (mm), and the symbol S denotes a pixel size in millimeters (i.e., sensor size divided by sensor resolution). Modelled bounding box dimensions δx and δy (i.e. bounding box lengths along the X and Y axes) are computed accordingly (see FIG. 2):

dx=(Dx*f)/(H*S)

dy=(Dy*f)/(H*S)

where the symbols Δx and Δy denote an object's physical dimensions (in centimeters), the symbol H denotes a distance between the camera system 20 and the object 12 (in centimeters), the symbol f denotes a camera focus length in millimeters (mm), and the symbol S denotes a pixel size in millimeters (i.e., sensor size divided by sensor resolution). Although centimeters are used as a measurement unit in this embodiment, any metric length unit can be used to practice the present disclosure. All distance measurements in the present application can use any of the metric lengths units, including centimeters and inches, and any variations or equivalents of the metric lengths units. The term “modelled” can also be referred to as “modeled”.

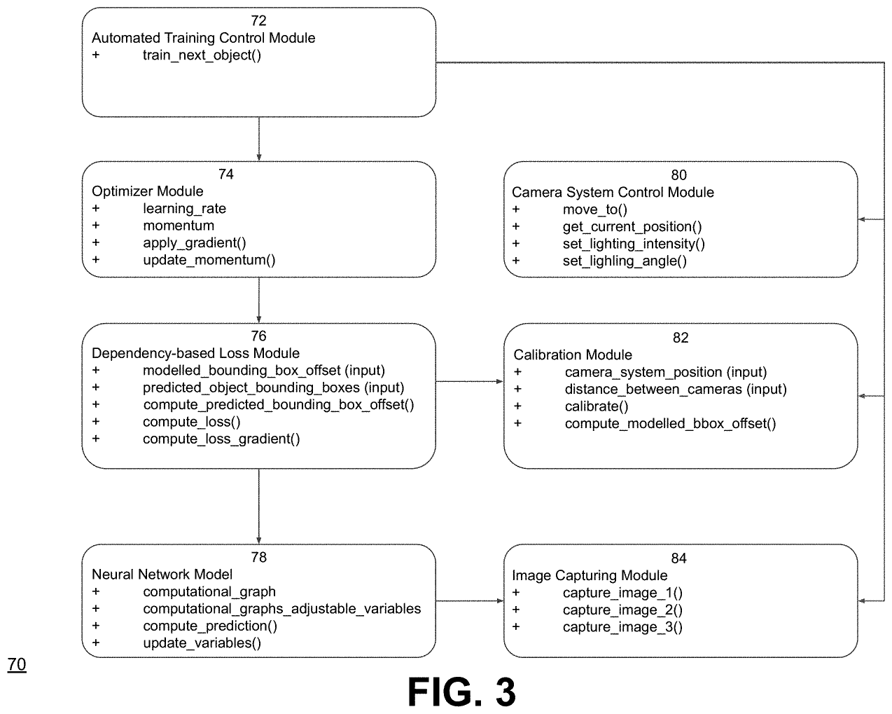

The camera system 20 is equipped with one or more controlled light sources 28. The camera system 20 is also equipped with suitable software blocks, implementing calibration, image capturing, camera system movement control and etc., as shown in FIG. 3.

In one embodiment, the object detection neural network model 30 is implemented as a software module, implementing one of object detection deep-learning architectures (e.g. SSD, F-RCNN, YOLO or similar), which comprises a computational graph, that is configured to receive an image pixel values as an input and return a list of object bounding box and class ID predictions as an output.

A computational graph includes a number of elementary numeric operations (e.g. sum, multiplication, thresholding, max-pooling, etc.) and a number of adjustable parameters, such as weights, biases, thresholds and others.

P=F(I,W₁,W₂ . . . Wⱼ)

where the symbol I denotes an input image, the symbol F denotes a function representing computational graph, the symbol Wj denotes one or more adjustable parameters, which j is an integer number from 1, 2, 3 . . . j, and the symbol P denotes a list of predicted object bounding boxes and class IDs.

A dependency-based Loss Function 40 can be implemented as a software module, configured to define and compute object detection neural network model predictive capability as a sum of: (i) the discrepancy between modelled bounding box offset M and the offset between predicted object bounding boxes associated with images from neighboring cameras; (ii) the discrepancy between modelled bounding box dimensions dx and dy and predicted bounding box dimensions; (iii) predefined penalty value added in case of any of predicted class identifiers differs from the object's class identifier, specified during the configuration and initialization of the neural network model (30) (since it is known that all cameras 22, 24, 226 in the camera system 20 are observing the same object); (iv) second predefined penalty value, added in case of there is more than one bounding box and class identifier predicted for each dependent image (since it is known that only one object is depicted on each of the dependent images).

$$BoundingBoxOffsetDiscrepancy ( {P}_{1} , … , {P}_{N} ) = {\sum }_{j = 1 … N - 1} {( Offset ( {P}_{j} , {P}_{j + 1} ) - M )}^{2}$$

$$BoundingBoxDimensionsDiscrepancy ( {P}_{1} , … , {P}_{N} ) = {\sum }_{j = 1 … N}^{ } {( DimX ( {P}_{j} ) - dx )}^{2} + {\sum }_{j = 1 … N}^{ } {( DimY ( {P}_{j} ) - dy )}^{2}$$

where the symbol Pⱼ represents bounding box predicted by neural network model for image from camera j, Offset( ) represents the function computing the offset between two bounding boxes, the symbol M represents the modelled bounding box offset between neighbouring cameras, DimX( ) and DimY( ) represent the functions computing bounding box dimensions. Alternatively, the Discrepancy computation in this equation can be of the sum of absolute values, rather than just the sum of squares.

The optimizer 50 is a software module, configured to adjust parameters of the neural network model 30 according to Stochastic Gradient Descent, or Adaptive Moment Estimation, or Particle Filtering, or other optimization algorithm, using dependency based loss function 40 as optimization criteria.

In one embodiment, a workspace is a flat or semi flat surface with some markup (also can be borders, fixing damps, etc.) at the center to provide easy object centering and fixation.

The systems and methods for automated training of object detection neural networks in the present disclosure are applicable to various environments and platforms, including, but not limited to, a robotic kitchen, video surveillance, autonomous driving, industrial packaging inspection, planogram compliance control, aerial imaging, traffic monitoring, device reading, point of sales monitoring, people counting, license plate recognition and etc. For additional information on robotic kitchen, see the U.S. Pat. No. 9,815,191 entitled “Methods and Systems for Food Preparation in a Robotic Cooking Kitchen,” U.S. patent Ser. No. 10/518,409 entitled “Robotic Manipulation Methods and Systems for Executing a Domain-Specific Application in an Instrumented Environment with Electronic Minimanipulation Libraries,” a pending U.S. non-provisional patent application Ser. No. 15/382,369, entitled “Robotic Minimanipulation Methods and Systems for Executing a Domain-Specific Application in an Instrumented Environment with Containers and Electronic Minimanipulation Libraries,” and a pending U.S. non-provisional patent application Ser. No. 16/045,613, entitled “Systems and Methods for Operating a Robotic System and Executing Robotic Interactions,” the subject matter of all of the foregoing disclosures of which are incorporated herein by reference in their entireties.

FIG. 2 is a graphical diagram illustrating the modelled object bounding box offset computation for the case of camera system 20 with a first camera plane 22a, a second camera plane 24a aligned with a first camera plane and a third camera plane 26a aligned with a first and second camera planes.

FIG. 3 is a software system diagram illustrating an object detection engine 70 having a plurality of modules in the system for automated training of object detection neural networks, including an automated training control module 72 configured to control the overall training of a new object, a camera system control module 80 configured to perform moving the camera system and changing light intensity or angle, a calibration module 82 configured to compute or obtain camera calibration parameters (focus length, optical center, distortion coefficients, pixel size, etc.), and to compute modelled bounding box offset, an image capturing module 84 configured to capture images from cameras, an object detection neural network model 78 configured to predict object bounding boxes and class identifiers (“class IDs”) for a given input image, and to update (or store) adjustable computation parameters (also referred to as variables), a dependency based loss module 76, configured to compute predicted bounding box offset, loss value, based on discrepancy between predicted and modelled bounding box offsets as well as class identifiers consistency and (to compute) loss gradient direction, and an optimizer module 74 configured to adjust neural network model parameters to minimize the loss value, by applying loss gradient according to the optimization algorithm (one of Stochastic Gradient Descent, Adaptive Moment Estimation or similar), or by applying Particle Filtering, or other suitable optimization algorithm.

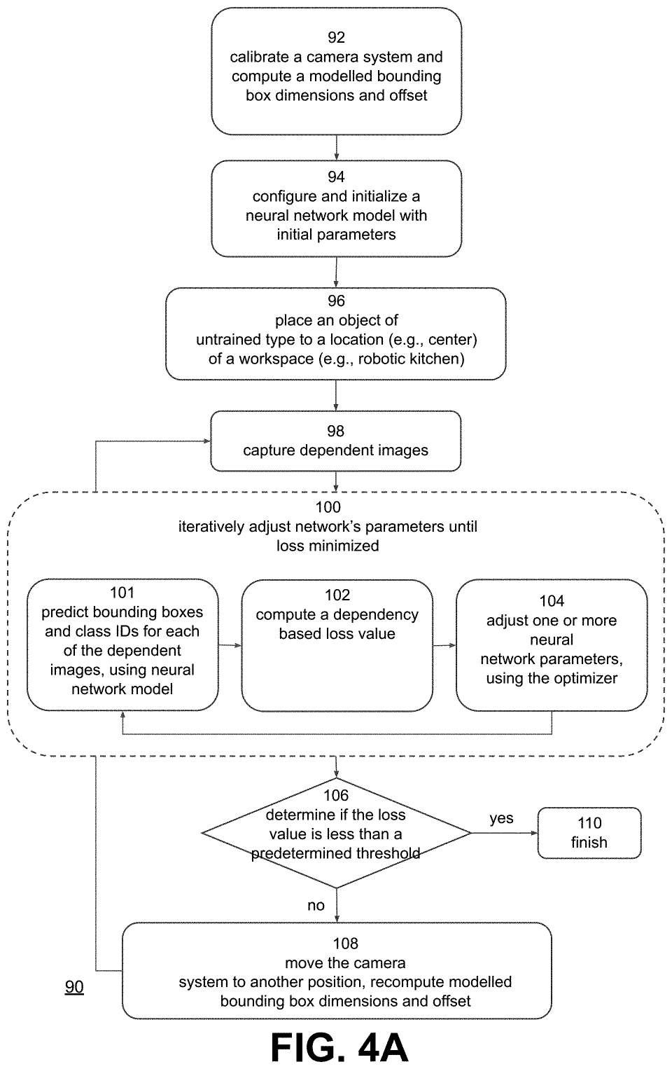

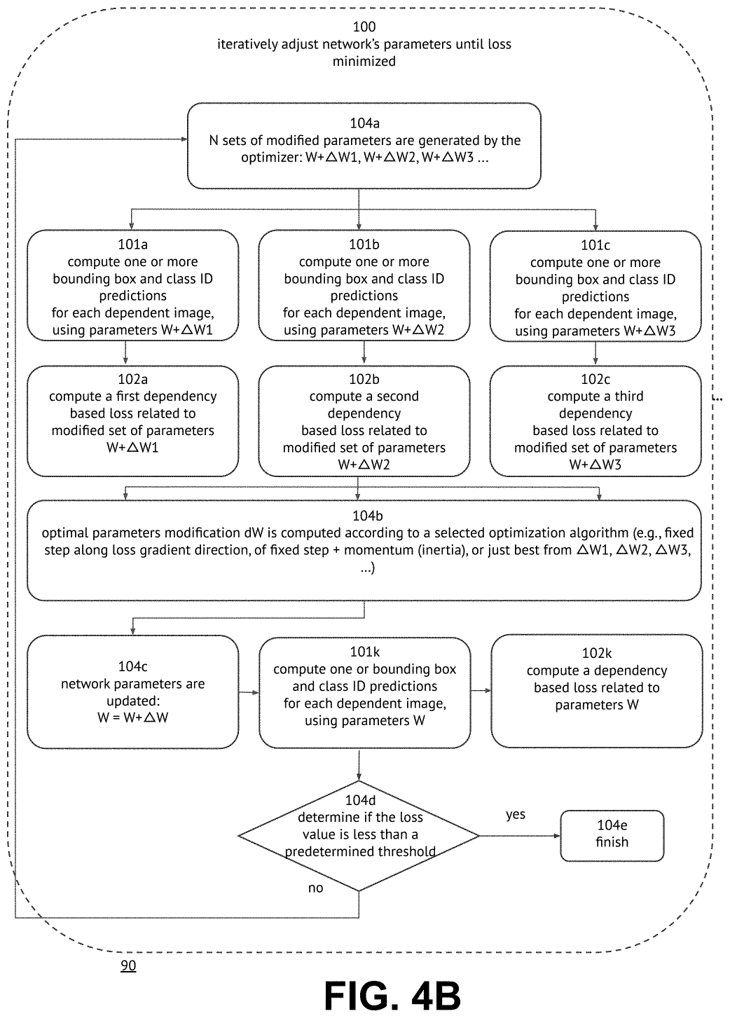

FIG. 4A is a flow diagram illustrating the process of functional steps of the system for automated training of object detection neural networks. At step 92, the cameras 22, 24, 26 in the camera system 20 are calibrated and modelled bounding box offset and dimensions are computed. At step 94, the neural network model 78 is configured and initialized with an initial set of parameters W=W₀. The initial set of parameters includes a set of random values, or predetermined parameters from an existing neural network. At step 96, an object of untrained type is placed to a predefined location, for example, at the center of the workspace. One example of the workspace is a flat or substantially surface in a robotic kitchen. At step 98, the cameras 22, 24, 26 in the camera system 20 capture dependent images of the object 12. At step 100, (a processor or) an automated training engine 70 is configured to iteratively adjust network's parameters until the loss is minimized, which includes steps 101, 102 and 104. At step 101, the automated training engine 70 is configured to predict the object bounding boxes and class identifiers for each dependent image by performing forward pass of the object detection neural network model 30, using current parameters W=(w₁,w₂ . . . wₖ). A single forward pass of the object detection neural network model may produce zero or more predicted bounding boxes and class identifiers for each image. At step 102, the dependency based loss function 40 is configured to compute the loss value as a sum of (1) discrepancy between modelled bounding box offset M and the offset between predicted object bounding boxes associated with neighboring cameras; (2) discrepancy between modelled bounding box dimensions ⊗x (also referred to as dx) and ⊗y (also referred to as dy) and dimensions of predicted bounding boxes; (3) a first penalty value, added in case of one or more of predicted class identifiers differ from others (or optionally from class identifier specified by the operator), and (4) a second penalty value, added in case of more than one object per image is predicted. At step 104 the optimizer 50 is configured to adjust the object detection neural network model's 30 parameters, using the loss value(s) and Stochastic Gradient Descent, Adaptive Moment Estimation, Particle Filtering or other optimization algorithm. In some embodiments, optimizer 50 is configured to compute intermediate loss values for one or more temporary sets of modified parameters and use this for better adjustment of parameters, as illustrated in FIG. 4B.

At step 108, the first camera 22, the second camera 24 and the third camera 25 in the camera system 20, moves to a new position and/or light conditions are changed. Consequently, the modelled bounding box offset and dimensions values are recomputed. Steps 98 through 108 are repeated for all possible light conditions and camera system positions. The automated training engine 70 is configured to determine if the loss value is less than the threshold, and if so, the process is completed at step 110.

Subsequent object of untrained type is placed to the center of the workspace and steps 98-110 are repeated. In some embodiments, the automated training engine 70 is configured to capture sufficient sets of dependent training images, in combination with dependency based loss function, which enables automated training of object detection neural networks without any use of ground truth data.

In some embodiments, a system for automated training of object detection neural networks of the present disclosure is equipped with an image analysis module and operates as follows. First, the image analysis module is configured to compute expected bounding box dimensions using background subtraction and color based image segmentation. Second, the system initializes the neural network model (with a random set of parameters W0, or from an existing neural network with a predetermined set of parameters). Second, the system captures two or more images of the same object “A”, using two or more different cameras, with a predetermined rotation and translation between each camera and the object and dose angle. Third, the system passes images through the neural network with Wi (i=0, 1, 2 . . . , first pass is starting from W0; on other stages Wi is the parameter values, determined by the optimizer) and computes predicted bounding boxes and class Identifiers. Fourth, the system computes loss value as a sum of (absolute value of each difference is used, e.g. without negative mark): (i) by comparing received offset from neural network bounding boxes and modelled offset difference using geometrical equations; (ii) by comparing the dimensions (e.g., width and length) of received neural network bounding boxes and expected bounding box dimensions, computed using image analyzer; and (iii) by comparing class identifiers with ground truth class identifier, which we take from the user (operator) and adding a penalty value (for example, in pixels, like 5 pixels, which has previously defined by an external source). Fifth, the optimizer executes an optimization algorithm, to find the parameters of the neural network model, that minimizes the loss value and brings it to nearby zero value. For that, optimizer executes steps 3 and 4 by optimizing parameters Wi until the value, computed by the dependency based loss function becomes nearby zero or zero. After processing the above 5 steps, the resultant object detection neural network is self-trained to detect and identify object A.

FIG. 4B is a flow diagram illustrating one embodiment of the step 100 from FIG. 4A for some embodiments, where an optimizer 50 is configured to store the history of computed loss values and respective neural network model parameters and use it (a processor or) an automated training engine 70 is configured to iteratively adjust network's parameters until the loss is minimized, that includes steps 101a, 101b, 101c, 102a, 102b, 102c, 104a, 104b, 104c, 104d, 104e. At the step 104a, the optimizer 50 is configured to generate J sets of modified parameters (W+⊗W1, W+⊗W2, W+⊗W3, . . . ) according to the used optimization algorithm. At the step 101a object detection neural network model 30 is configured to compute bounding box and class ID predictions for each of the dependent images using modified parameters W+⊗W1. At the step 102a, dependency based loss is computed for bounding box and class ID predictions computed on the step 101a. At the step 101b object detection neural network model 30 is configured to compute bounding box and class ID predictions for each of the dependent images using modified parameters W+⊗W2. At the step 102b, dependency based loss is computed for bounding box and class ID predictions computed on the step 101b. At the step 101c object detection neural network model 30 is configured to compute bounding box and class ID predictions for each of the dependent images using modified parameters W+⊗W3. At the step 102c, dependency based loss is computed for bounding box and class ID predictions computed on the step 101c. In a similar way, dependency based loss value is computed for each of the modified parameters, generated on the step 104a. At the step 104b, the optimizer 50 is configured to compute optimal parameters modification ⊗W (also referred to as “dW”) based on modified parameters, generated at the step 104a and respective loss values, computed at the steps 102a, 102b, 102c, according to the used optimization algorithm. In some embodiments, at the step 104b loss gradient direction is computed and parameters modification vector ⊗W is computed as a fixed (or dynamically modifiable) step along the loss gradient direction, plus some inertia momentum (e.g. Stochastic Gradient Descent, Adaptive Moment Estimation and similar). At the step 104c parameters of the object detection neural network model 30 is updated with computed on step 104b modification vector: W=W+⊗W. At the step 101k, the object detection neural network model 30 is configured to compute bounding box and class ID predictions for each of the dependent images using modified parameters W+⊗W. At the step 102k, dependency based loss is computed for bounding box and class ID predictions computed on the step 101k. At the step 104e, loss value computed on the step 102k is compared against the threshold and in case of it is less, the optimization process 100 is finished, overwise steps 104a-104e are repeated again.

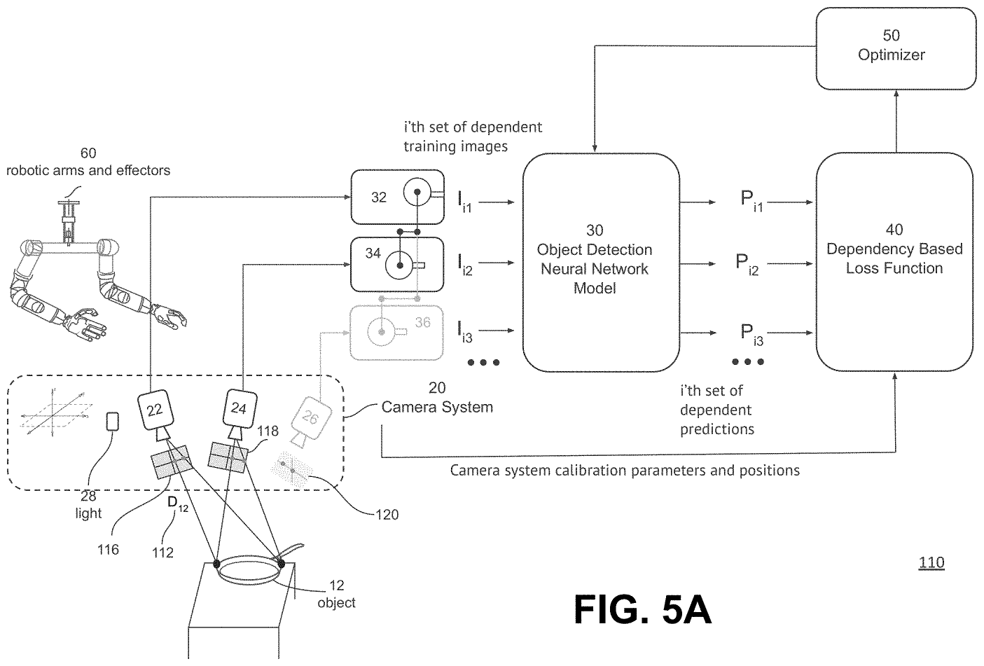

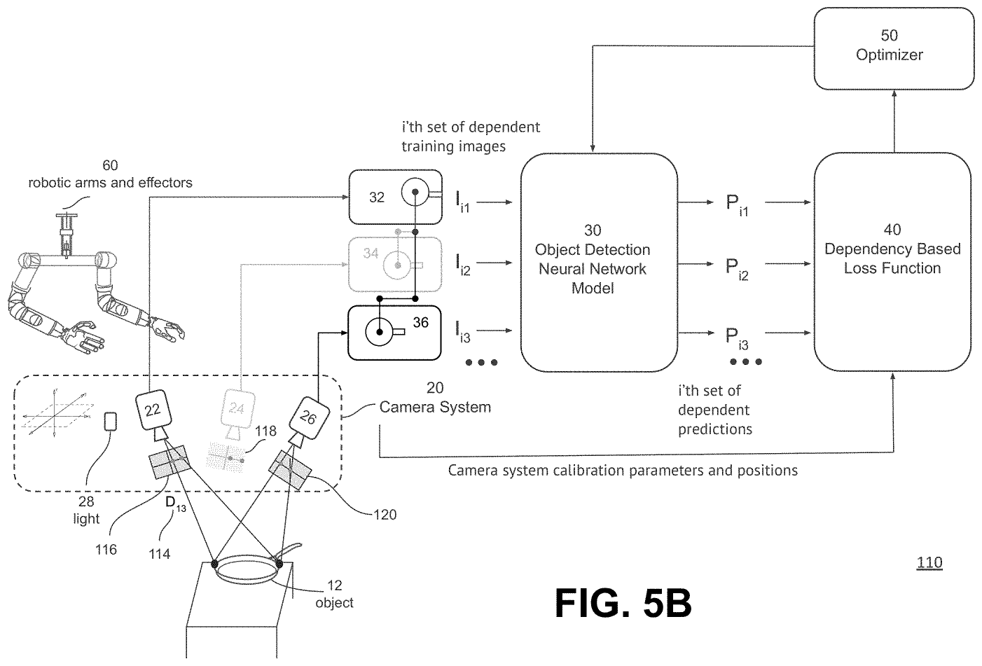

FIG. 5A is a system diagram illustrating a second embodiment of the system for automated training of object detection neural networks 10 with a first stereo pair highlighted, that consists of the first camera and the second camera. In one embodiment, the camera system 20 comprises three or more unaligned cameras arranged at various distances and/or angles between them. In some embodiments, since all cameras are observing the same object at a time, physical object coordinates within each set of simultaneously captured images are also the same, which enables to compute dependency based loss as a sum of: (i) discrepancy between physical object coordinates, computed by stereo pair, organized from the first camera 22 and the second camera 24, as shown in FIG. 5A and physical object coordinates, computed by stereo pair, organized from the first camera 22 and third camera 26, as shown in FIG. 5B; (ii) the discrepancy between modelled bounding box dimensions ⊗x and ⊗y and predicted bounding box dimensions; (iii) predefined penalty value added in case of any of predicted class identifiers differs from the object's class ID, specified during the configuration and initialization of the neural network model (30) (since it is known that all cameras 22, 24, 226 in the camera system 20 are observing the same object); (iv) second predefined penalty value, added in case of there is more than one bounding box and class ID predicted for each dependent image (since it is known that only one object is depicted on each of the dependent images).

$$CoordinatesDiscrepancy ( {P}_{1} , … , {P}_{N} ) = {\sum }_{j = 1 … N - 1}^{ } {( {D}_{1 j} ( {P}_{1} , {P}_{j} ) - {D}_{1 j + 1} ( {P}_{1} , {P}_{j + 1} ) )}^{2}$$

where the symbol Pⱼ represents the object bounding box predicted by neural network model for image captured by camera j, and symbol D₁ⱼ represents the function reflecting the computation of physical object coordinates with respect to the first camera 22, using stereo parameters for 1-j stereo camera pair, using bounding box predictions, associated with images from cameras 1 and j respectively.

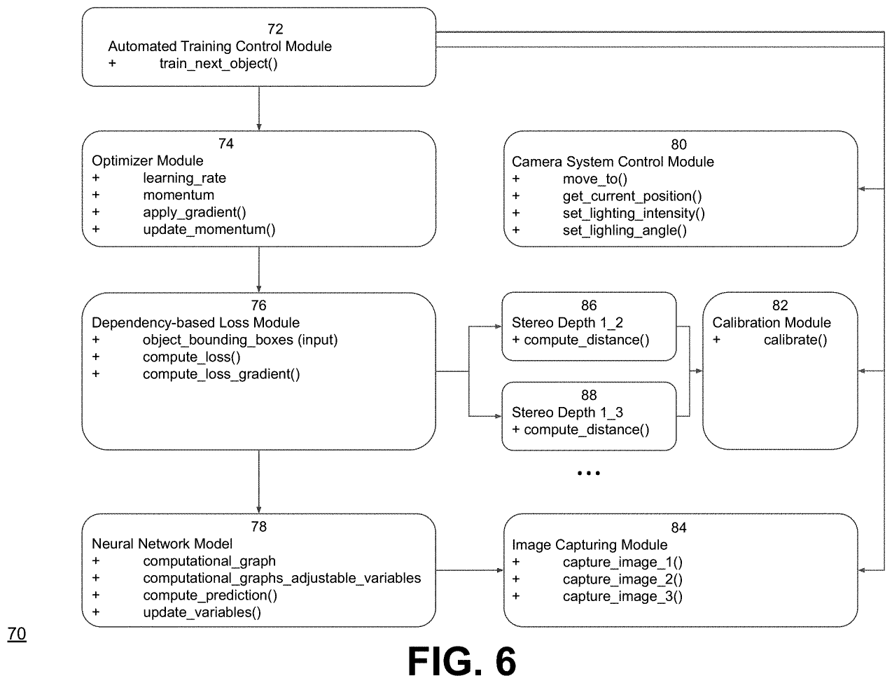

FIG. 6 is a software system diagram illustrating a second embodiment of a system for automated training of object detection neural networks 10 with a plurality of stereo depth modules 86 and 88, configured to compute physical object coordinates from bounding box predictions with respect to stereo camera pairs, organized from the first camera 22 and the second camera 24 (cameras 1-2, or camera one and camera two), the first camera 22 and the third camera 26 (cameras 1-3, or camera one and camera three), as well as other combinations, such as the first camera 22, the second camera 24, the third camera 26, and a the first and the fourth camera (cameras 1-4, or camera one and camera four), as reflected by the plurality of stereo depth modules 86 and 88 in FIG. 6.

Each of the stereo depth modules 86, 88 uses calibration parameters, computed by the calibration module 82: focus length(s), optical center(s), distortion coefficients, rotation and translation between first and second cameras, between first and third, between first and fourth and etc., as well as fundamental, essential and projection matrices.

The stereo depth module 86 (also referred to as Stereo Depth 1_2) receives predicted bounding boxes for images from first and second cameras and computes the distance (in some embodiments—translation vector) between the first camera and the object using triangulation formula (in some embodiments, by using rectification transform and disparity based depth computation).

Accordingly, the stereo depth module 88 (also referred to as Stereo Depth module 1_3) receives predicted bounding boxes for images from first and third cameras and computes the distance (in some embodiments—translation vector) between the first camera and the object.

Since physical object coordinates within each set of simultaneously captured images is the same, the difference between distances 1_2 and 1_3 (as well as the difference between distances 1_3 and 1_4, and the difference between the distances 1_4 and 1_5, and other pairs) should be nearby zero in case of accurate bounding boxes prediction and higher values otherwise, so can be used a loss value. In one embodiment, the term “distance 1_2” represents a physical distance between the object and a first camera, computed from predicted bounding boxes associated with images from first and second camera using triangulation; the term “distance 1_3” represents a physical distance between the object and a first camera, computed from predicted bounding boxes associated with images from first and third camera using triangulation. Since, both distance 1_2 and distance 1_3 relate to the same physical distance, the difference between them should be zero, in case the predicted bounding boxes are accurate.

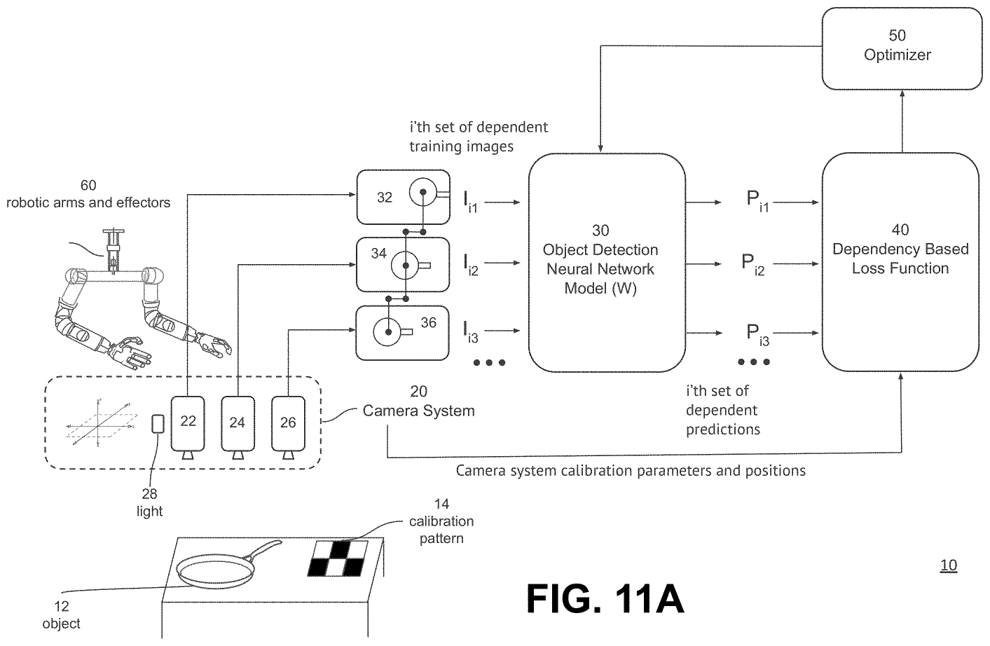

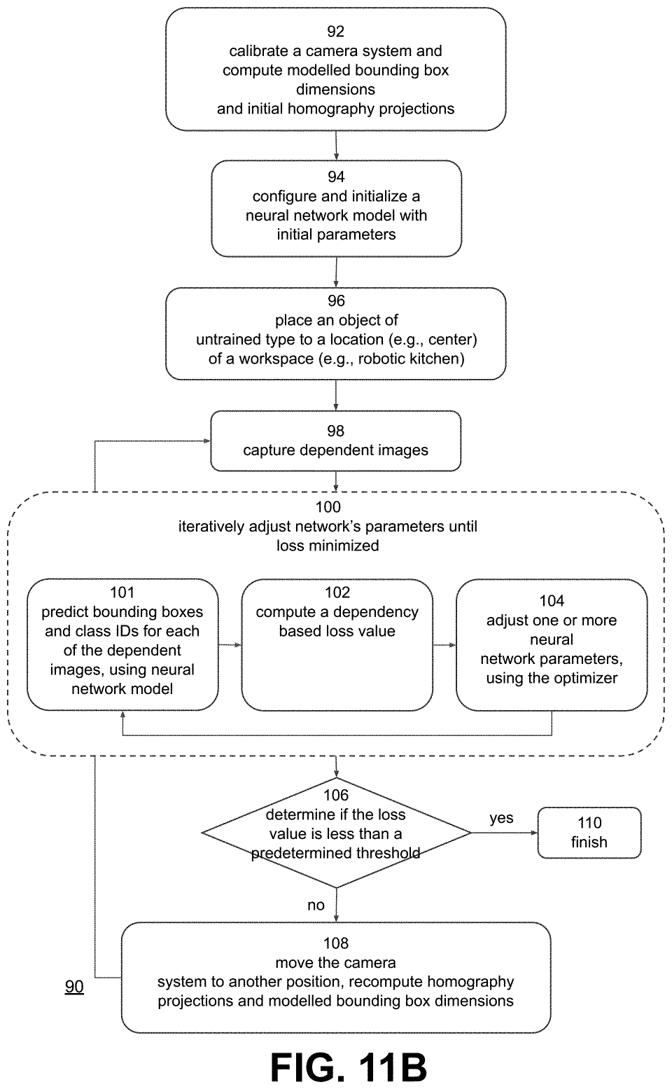

FIGS. 11A and 11B illustrate a fifth embodiment of the system diagram and a flow diagram, respectively, for automated training of object detection neural networks, wherein workspace is additionally equipped with permanent calibration pattern (14) (one of chessboard pattern, circles pattern, set of aruco or other square markers or other), which enables to compute the projection (e.g. homography) between each camera plane and workspace surface and so to compute physical object coordinates with respect to calibration pattern, from bounding box predicted for the image from respective camera. For this embodiment, dependency based loss function is configured to compute a sum of: (i) discrepancy between object physical coordinates, estimated from different camera; (ii) the discrepancy between modelled bounding box dimensions dx and dy and predicted bounding box dimensions; (iii) predefined penalty value added in case of any of predicted class identifiers differs from the object's class ID, specified during the configuration and initialization of the neural network model (30) (since it is known that all cameras 22, 24, 226 in the camera system 20 are observing the same object); (iv) second predefined penalty value, added in case of there is more than one bounding box and class ID predicted for each dependent image (since it is known that only one object is depicted on each of the dependent images);

$$CoordinatesDiscrepancy ( {P}_{1} , … , {P}_{N} ) = {\sum }_{j = 1 … N - 1}^{ } {( {H}_{j} ( {P}_{j} ) - {H}_{j + 1} ( {P}_{j + 1} ) )}^{2}$$

where the symbol Pⱼ represents the object bounding box predicted by neural network model for image captured by camera j, and symbol Hⱼ( ) represents the function reflecting the computation of physical object coordinates with respect to the calibration pattern, by homography projection between j'th camera plane and workspace plane, using predicted bounding box, associated with image from camera j.

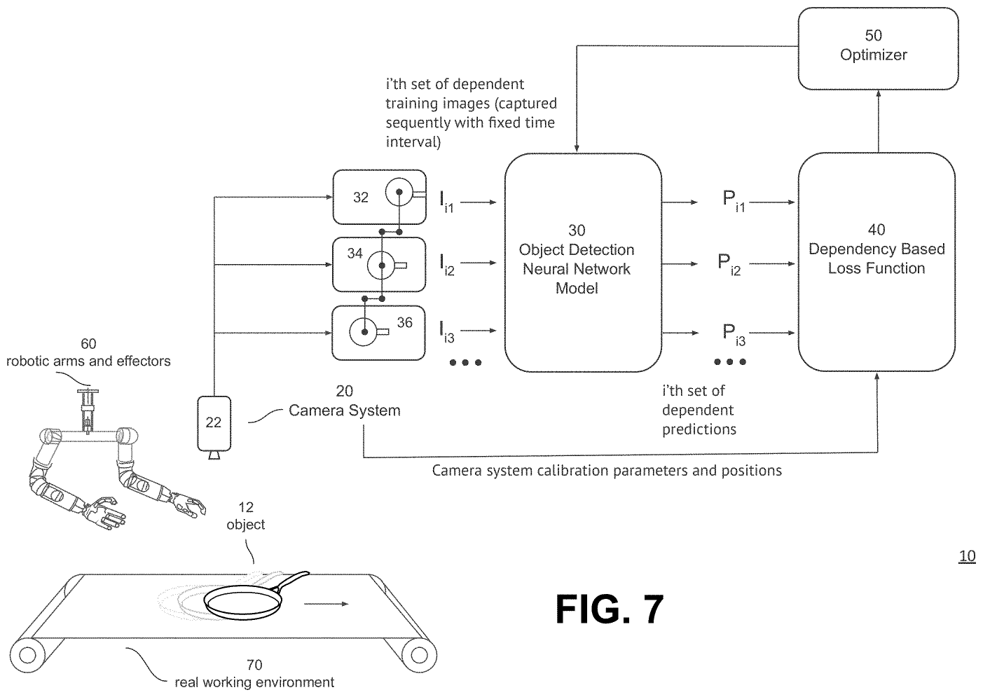

FIG. 7 is a block diagram illustrating a third embodiment of the system for automated training of object detection neural networks 10. In this embodiment, the system for automated training of object detection neural networks 10 comprises a working environment (to observe object in its natural surrounding) where objects are moving with known velocity along the known trajectories (e.g. conveyor and etc.), which enables to compute dependency based bounding box loss as a sum of: (i) discrepancy between modelled bounding box offset value and offset between predicted object bounding boxes associated with images sequentially captured by the same camera with known time interval T; and (ii) the discrepancy between modelled bounding box dimensions ⊗x and ⊗y and predicted bounding box dimensions; and (iii) a predefined penalty value added in case of any of predicted class identifiers differs from the object's class ID, specified during the configuration and initialization of the neural network model (30); and (iv) a second predefined penalty value, added in case of there is more than one bounding box and class ID predicted for each dependent image. Alternatively, the system for automated training of object detection neural networks 10 comprises an instrumented environment where objects are moving with known velocity along the known trajectories. For additional information instrumented environment, see the U.S. Pat. No. 9,815,191 entitled “Methods and Systems for Food Preparation in a Robotic Cooking Kitchen,” and U.S. patent Ser. No. 10/518,409 entitled “Robotic Manipulation Methods and Systems for Executing a Domain-Specific Application in an Instrumented Environment with Electronic Minimanipulation Libraries,” the subject matter of all of the foregoing disclosures of which are incorporated herein by reference in their entireties.

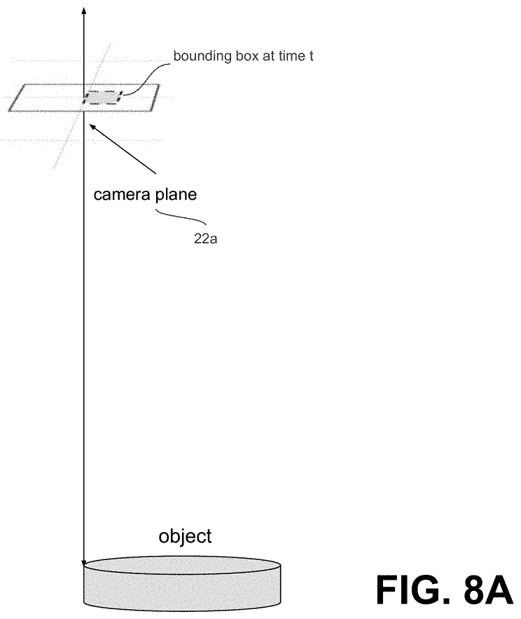

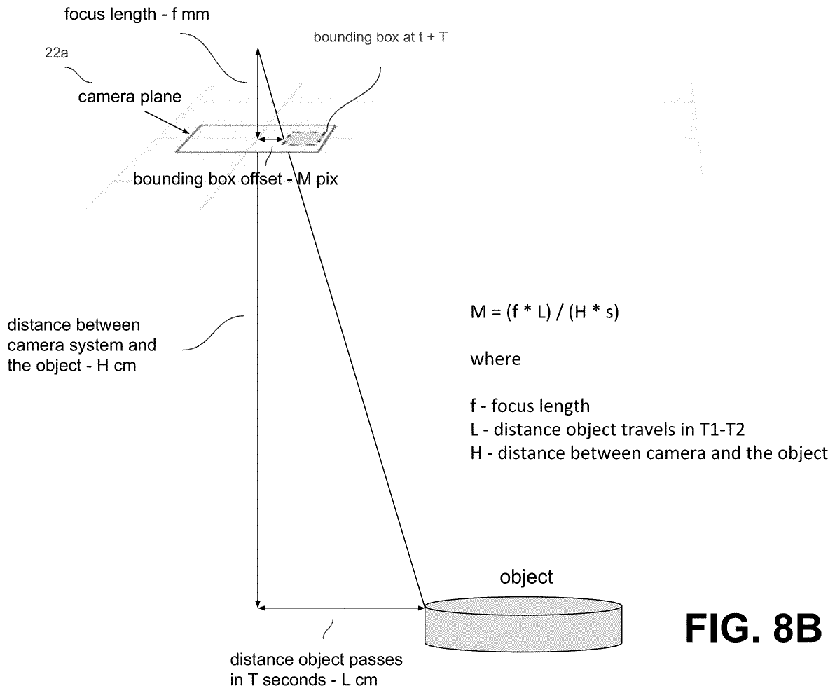

FIGS. 8A and 8B are graphical diagrams illustrating the computation of modelled bounding box offset for the case of static camera and object moving along its x-axis with constant velocity, which results in a modelled bounding box offset being a constant. For other embodiments, a more complex function of environment configuration and camera position would be adopted.

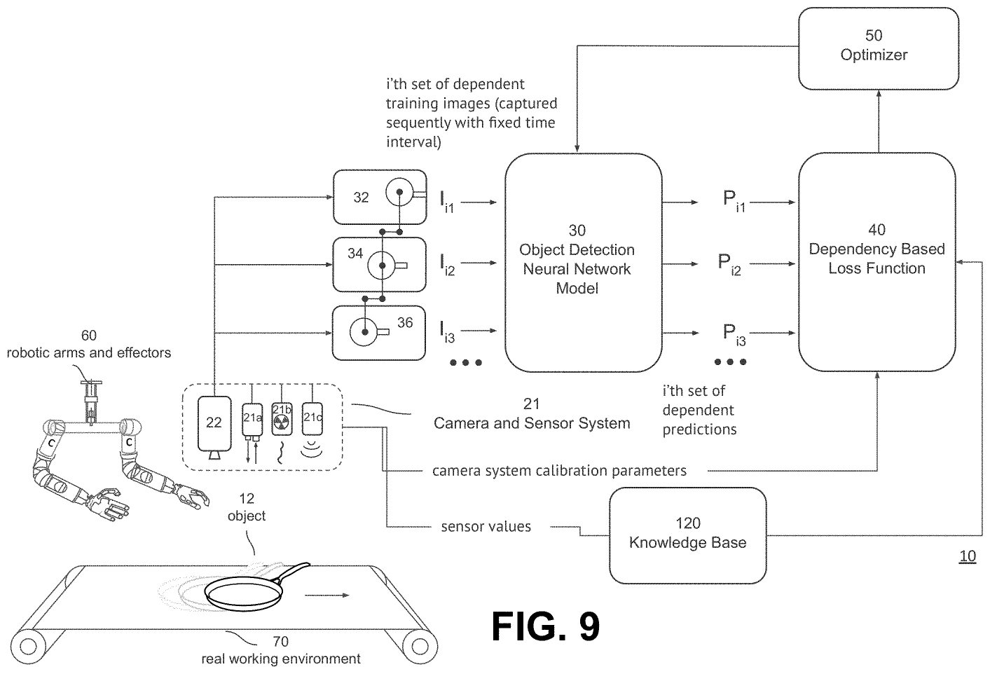

FIG. 9 is a block diagram illustrating a fourth embodiment of the system for automated training of object detection neural networks 10 with a camera and sensor system 21 and a knowledge base 120. In this embodiment, the system for automated training of object detection neural networks 10 includes a plurality of sensors 21a, 21b, 21c in the camera and sensor system 21, which enables to imply additional limitations on predicted object bounding boxes or class identifiers.

For example, weight sensor enables to determine if there is an object in the workspace and its type (or list of possible types), temperature sensor enables to determine the state of an object (free, in use, hot, cold, etc.), ultrasonic sensor enables to compute distance to the object and etc.

Values from additional sensors are supplied to the Knowledge Base Module, which contains various facts and rules about target objects and environment.

Object bounding box and class ID predictions that don't fit knowledge base rules are penalized:

$${Loss\_dep}_{ext} ( {P}_{1} , {P}_{2} , … ) = Loss\_dep ( {P}_{1} , {P}_{2} , … ) + {\sum }_{i , j} {G}_{i} ( {C}_{j} , {P}_{j} )$$

where
the symbol Pⱼ represents the prediction made by neural network model for image captured at the moment T*j
the symbol Loss_dep ( ) represents the dependency based loss from claims 1-2-3
the symbol Cⱼ represents sensor values captured at the moment T*j
the symbol Gᵢ(C,P) represents the penalty function, introduced by the i'th knowledge base rule, that measures the discrepancy between prediction P and sensor values C or between prediction P and some prior knowledge about the environment or object.

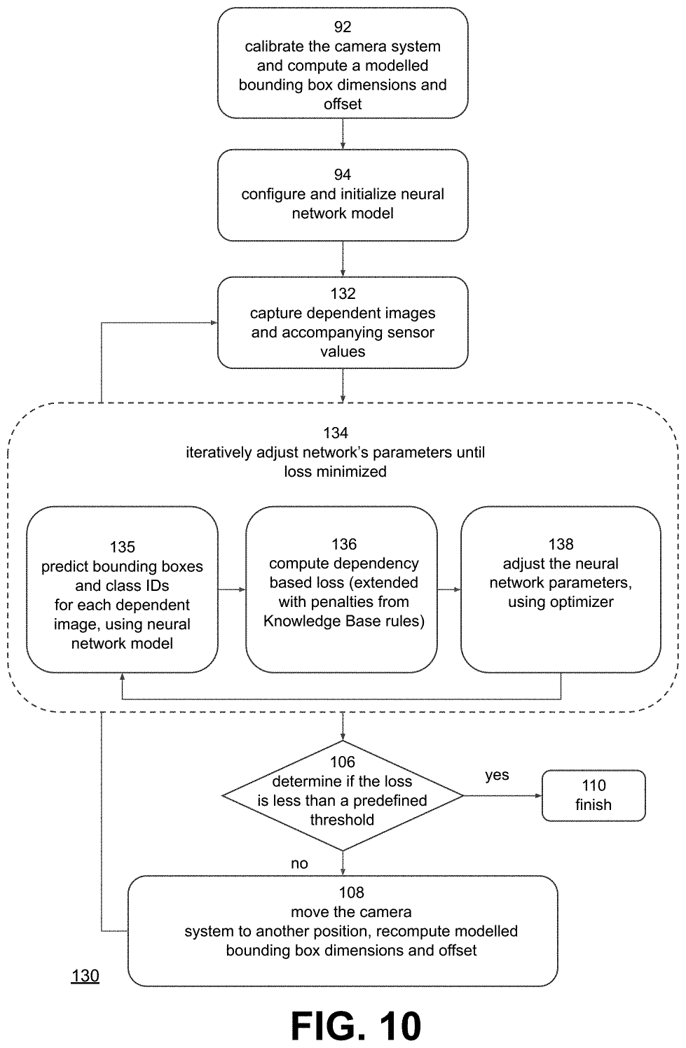

FIG. 10 is a flow diagram illustrating the fourth embodiment of the process 130 for automated training of object detection neural networks with one or more sensors and knowledge base rules. The knowledge base 120 includes knowledge base rules, as examples but not limited to: sensor based object presence/absence, sensor based object position and orientation limitations, bounding box and class identifier limitations based on synchronous observations that takes in concern physical or other nature of monitored object (e.g. digital docks are known to change their values periodically and in order, so capturing its image every minute guarantees that values depicted on neighboring in time images will differ by one), environment topology and principles (e.g. possible object trajectories, locations objects can only appear/disappear at, locations where the object is closer and so the bounding box is bigger, than in some other locations, less and more probable locations of the object etc.), sensor based object class ID (which in some embodiments is configured to identify objects state) limitations (e.g. hot, cold, free, in use and etc.), and object structure and topology (e.g. allowed/disallowed bounding box aspect ratios, size and etc.).

At step 132, the camera and sensors system 21 sequentially captures a series of workspace images (i.e. dependent images) and accompanying sensor values with time interval T. At step 135, the object bounding boxes and class identifiers are predicted for each of the images by performing forward pass of the object detection neural network model, using current parameters W=(w₁,w₂ . . . wₖ).

At steps 134, 136, 138, the Loss value is computed as a sum of (i.e. Dependency Based Loss): (i) discrepancy between modeled bounding box offset value and offset between predicted object bounding boxes associated with images sequentially captured by the same camera with known time interval T; and (ii) the discrepancy between modeled bounding box dimensions ⊗x and ⊗y and predicted bounding box dimensions; and (iii) a predefined penalty value added in case of any of predicted class identifiers differs from the object's class ID, specified during the configuration and initialization of the neural network model (30); and (iv) a second predefined penalty value, added in case of there is more than one bounding box and class ID predicted for each dependent image; and (v) one or more predefined penalty values, added using Knowledge-Base rules. The predicted bounding boxes and class identifiers are compared against Knowledge Base rules and additional penalty value is added to the loss, in case one or more predictions do not comply with any of the rules: (a) weight sensor(s) values are compared against the weights of possible object types and expected numbers and types of the objects in the workspace are computed; additional penalty value is added to the loss, in case the number of predicted objects or respective class identifiers are not matching the corresponding expected values; (b) distance sensor(s) values are transmitted to the corresponding Knowledge Base rule, that computes object presence flag for a list of predefined locations; additional penalty value is added to the loss, in case of one or more predicted bounding boxes occupies “free” location or there is no matching bbox for any of the “busy” locations; (c) predicted bounding boxes and class identifiers are compared against the workspace topology; additional penalty value is added to the loss, in case of one or more predicted bounding box and class identifier pairs is holding unexpected position, has unexpected size, aspect rate or does not fit to allowed trajectory and etc.; (d) (in some embodiments wherein class identifier is configured to reflect object state, e.g. hot-frying-pan, cold-frying-pan, raw-steak, fried-steak, wet-sponge, dry-sponge and etc.) temperature, odor, humidity and etc. sensor(s) values are transmitted to the corresponding Knowledge Base rule that will check predicted class identifiers and increase the loss value in case of any discrepancy is detected; (e) predicted bounding boxes and class identifiers are compared against the stored object models (structure and topology info, allowed aspect ratios, bounding box sizes and etc.); additional penalty value is added to the loss, in case of any discrepancy is detected; and (f) other knowledge base rules are applied.

The optimizer 50 is configured to iteratively adjusts neural network parameters, for one specific example, but not limited to, by using Stochastic Gradient Descent, Adaptive Moment Estimation, Particle Filtering or other optimization algorithm, until the loss value, computed by the Dependency Based Loss Function 40 is minimized. For example, an optimization process may appear as follows: (1) compute a loss value by performing steps 135 and 136 with parameters W′=(w₁+step, w₂ . . . wₖ); (2) check if the loss was reduced and update network parameters (W=W′) in that case; (3) compute the loss value by performing steps 135 and 136 with parameters W′=(w₁−step, w₂ . . . wₖ); (4) check if loss was reduced and update network parameters (W=W′) in that case; (5) compute the loss value by performing steps 135 and 136 with parameters W′=(w₁, w₂+step . . . wₖ); (6) check if loss was reduced and update network parameters (W=W′) in that case; (7) compute the loss value by performing steps 135 and 136 with parameters W′=(w₁, w₂−step . . . wₖ); (8) check if the loss is reduced and update network parameters (W=W′) in that case; (9) repeat the steps for all parameters wi; (10) compute the loss value by performing steps 135 and 136 with parameters W′=(w₁, w₂ . . . wₖ+step); (11) check if the loss was reduced and update network parameters (W=W′) in that case; (12) compute the loss value by performing steps 135 and 136 with parameters W′=(w₁, w₂ . . . wₖ−step); (13) check if the loss is reduced and update network parameters (W=W′) in that case; (14) repeat steps (i-xiii) K times (or alternatively until no parameters are changed).

Finally, steps 132, 134, 135, 136, 138 are repeated until the loss value is minimized (minimum K times).

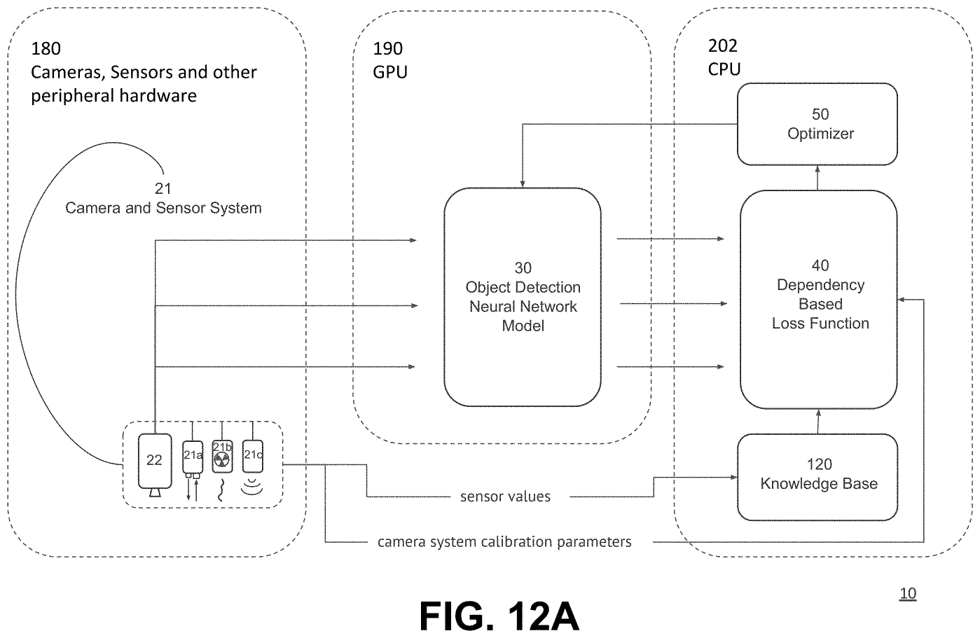

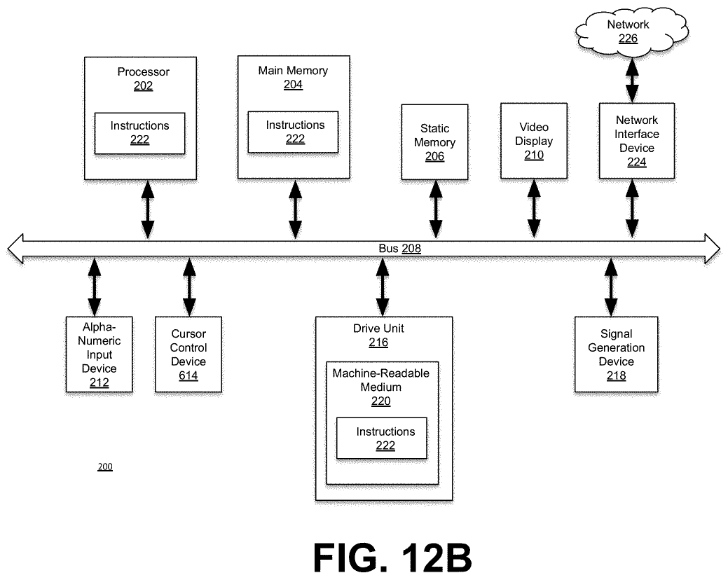

FIG. 12A is a block diagram 10 illustrating an example of a central processing unit 202 (CPU) and a graphics processing unit (GPU) 190 in operation with cameras,sSensors and other peripheral hardware 180 including the cameras 22, 24, 26 and sensors 21a, 21b, 21c. Data flow is started in the camera and sensors system 21 and continues to the GPU 190 hosting the object detection neural network model 30, then goes to the CPU 202 hosting the Knowledge Base 12, the Dependency Based Loss Function 40, and the Optimizer 50 and then back to the GPU 190.

As alluded to above, the various computer-based devices discussed in connection with the present invention may share similar attributes. FIG. 12B illustrates an exemplary form of a computer system 200, in which a set of instructions can be executed to cause the computer system to perform any one or more of the methodologies discussed herein. The computer devices 200 may represent any or all of the clients, servers, or network intermediary devices discussed herein. Further, while only a single machine is illustrated, the term “machine” shall also be taken to include any collection of machines that individually or jointly execute a set (or multiple sets) of instructions to perform any one or more of the methodologies discussed herein. The exemplary computer system 200 includes a processor 202 (e.g., a central processing unit (CPU), a graphics processing unit (GPU), or both), a main memory 204 and a static memory 206, which communicate with each other via a bus 208. The computer system 200 may further include a video display unit 210 (e.g., a liquid crystal display (LCD)). The computer system 200 also includes an alphanumeric input device 212 (e.g., a keyboard), a cursor control device 214 (e.g., a mouse), a disk drive unit 216, a signal generation device 218 (e.g., a speaker), and a network interface device 224.

The disk drive unit 216 includes a machine-readable medium 220 on which is stored one or more sets of instructions (e.g., software 222) embodying anyone or more of the methodologies or functions described herein. The software 222 may also reside, completely or at least partially, within the main memory 204 and/or within the processor 202. During execution the computer system 200, the main memory 204, and the instruction-storing portions of processor 202 also constitute machine-readable media. The software 222 may further be transmitted or received over a network 226 via the network interface device 224.

A system for automated training of deep learning based object detection system, comprising: (a) a calibrated camera system having two or more cameras for capturing two or more images of an object from a plurality of angles by a calibrated camera system, the two or more cameras having a predetermined position between each camera and the object; (b) a calibration module configured to generate a modelled bounding box offset and dimensions for any two cameras, the modelled bounding box having an approximate offset between two bounding boxes of the same object on images from two different cameras; (c) a neural network model configured to propagate the two or more images through a neural network model, thereby producing a predicted object bounding box and class identifier for each captured image, and generating a predicted bounding box offset between bounding boxes from images of neighboring cameras; (d) a dependency-based loss module configured to compute a loss value as a sum of: (i) a first penalty value computed as the discrepancy between the modelled bounding box offset and a predicted bounding box offset; and (ii) a second penalty value computed as the discrepancy between the modelled bounding box dimensions and dimensions of predicted bounding boxes from the same image in the two or more images captured by the camera system; and (e) an optimizer configured to adjust the plurality of neural network parameters Wi until the loss function is minimized to less than a predetermined threshold, based on an optimization algorithm and steps (c) and (d) for the loss computation with selected neural network parameters values.

A system, comprising a memory operable to store automated training of deep learning based object detection; and at least one hardware processor interoperably coupled to the memory and operable to: capturing two or more images of an object from a plurality of angles by a calibrated camera system, the two or more cameras having a predetermined position between each camera and the object; (b) generating a modelled bounding box offset and dimensions, the modelled bounding box having an approximate offset between two bounding boxes of the same object on images from two different cameras; (c) propagating the two or more images through a neural network model, thereby producing a predicted object bounding box and class identifier for each captured image, and generating a predicted bounding box offset between bounding boxes from images of neighboring cameras; (d) computing a loss value as a sum of a first penalty value computed as the discrepancy between the modelled bounding box offset and a predicted bounding box offset and a second penalty value computed as the discrepancy between the modelled bounding box dimensions and dimensions of predicted bounding boxes from the same image in the two or more images captured by the camera system; and (e) adjusting the plurality of neural network parameters Wi until the loss function is minimized to less than a predetermined threshold, based on an optimization algorithm and steps (c) and (d) for the loss computation with selected neural network parameters values.

A system comprising one or more computers; and at least one non-transitory computer-readable storage device storing instructions thereon that are executable by the one or more computers to perform operations comprising: capturing two or more images of an object from a plurality of angles by a calibrated camera system, the two or more cameras having a predetermined position between each camera and the object; (b) generating a modelled bounding box offset. and dimensions, the modelled bounding box having an approximate offset between two bounding boxes of the same object on images from two different cameras; (c) propagating the two or more images through a neural network model, thereby producing a predicted object bounding box and class identifier for each captured image, and generating a predicted bounding box offset between bounding boxes from images of neighboring cameras; (d) computing a loss value as a sum of a first penalty value computed as the discrepancy between the modelled bounding box offset and a predicted bounding box offset and a second penalty value computed as the discrepancy between the modelled bounding box dimensions and dimensions of predicted bounding boxes from the same image in the two or more images captured by the camera system; and (e) adjusting the plurality of neural network parameters Wi until the loss function is minimized to less than a predetermined threshold, based on an optimization algorithm and steps (c) and (d) for the loss computation with selected neural network parameters values.

At least one non-transitory computer-readable storage device storing instructions that are executable by one or more computers that, when received by the one or more computers, cause the one or more computers to perform operations comprising: capturing two or more images of an object from a plurality of angles by a calibrated camera system, the two or more cameras having a predetermined position between each camera and the object; (b) generating a modelled bounding box offset and dimensions, the modelled bounding box having an approximate offset between two bounding boxes of the same object on images from two different cameras; (c) propagating the two or more images through a neural network model, thereby producing a predicted object bounding box and class identifier for each captured image, and generating a predicted bounding box offset between bounding boxes from images of neighboring cameras; (d) computing a loss value as a sum of a first penalty value computed as the discrepancy between the modelled bounding box offset and a predicted bounding box offset and a second penalty value computed as the discrepancy between the modelled bounding box dimensions and dimensions of predicted bounding boxes from the same image in the two or more images captured by the camera system; and (e) adjusting the plurality of neural network parameters Wi until the loss function is minimized to less than a predetermined threshold, based on an optimization algorithm and steps (c) and (d) for the loss computation with selected neural network parameters values.

While the machine-readable medium 220 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any tangible medium that is capable of storing a set of instructions for execution by the machine and that cause the machine to perform anyone or more of the methodologies of the present invention. The term “machine-readable medium” shall accordingly be taken to include, but not be limited to, solid-state memories, and optical and magnetic media.

Some portions of the detailed descriptions herein are presented in terms of algorithms and symbolic representations of operations on data within a computer memory or other storage device. These algorithmic descriptions and representations are the means used by those skilled in the data processing arts to most effectively convey the substance of their work to others skilled in the art. An algorithm is here, and generally, conceived to be a self-consistent sequence of processing blocks leading to a desired result. The processing blocks are those requiring physical manipulations of physical quantities. Throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), erasable programmable ROMs (EPROMs), electrically erasable and programmable ROMs (EEPROMs), magnetic or optical cards, application specific integrated circuits (ASICs), or any type of media suitable for storing electronic instructions, and each coupled to a computer system bus. Furthermore, the computers and/or other electronic devices referred to in the specification may include a single processor or may be architectures employing multiple processor designs for increased computing capability.

Moreover, terms such as “request”, “client request”, “requested object”, or “object” may be used interchangeably to mean action(s), object(s), and/or information requested by a client from a network device, such as an intermediary or a server. In addition, the terms “response” or “server response” may be used interchangeably to mean corresponding action(s), object(s) and/or information returned from the network device. Furthermore, the terms “communication” and “client communication” may be used interchangeably to mean the overall process of a client making a request and the network device responding to the request.

In respect of any of the above system, device or apparatus aspects, there may further be provided method aspects comprising steps to carry out the functionality of the system. Additionally or alternatively, optional features may be found based on any one or more of the features described herein with respect to other aspects.

The present disclosure has been described in particular detail with respect to possible embodiments. Those skilled in the art will appreciate that the disclosure may be practiced in other embodiments. The particular naming of the components, capitalization of terms, the attributes, data structures, or any other programming or structural aspect is not mandatory or significant, and the mechanisms that implement the disclosure or its features may have different names, formats, or protocols. The system may be implemented via a combination of hardware and software, as described, or entirely in hardware elements, or entirely in software elements. The particular division of functionality between the various system components described herein is merely exemplary and not mandatory; functions performed by a single system component may instead be performed by multiple components, and functions performed by multiple components may instead be performed by a single component.

In various embodiments, the present disclosure can be implemented as a system or a method for performing the above-described techniques, either singly or in any combination. The combination of any specific features described herein is also provided, even if that combination is not explicitly described. In another embodiment, the present disclosure can be implemented as a computer program product comprising a computer-readable storage medium and computer program code, encoded on the medium, for causing a processor in a computing device or other electronic device to perform the above-described techniques.

As used herein, any reference to “one embodiment” or to “an embodiment” means that a particular feature, structure, or characteristic described in connection with the embodiments is included in at least one embodiment of the disclosure. The appearances of the phrase “in one embodiment” in various places in the specification are not necessarily all referring to the same embodiment.

It should be borne in mind, however, that all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing” or “computing” or “calculating” or “displaying” or “determining” or the like refer to the action and processes of a computer system, or similar electronic computing module and/or device, that manipulates and transforms data represented as physical (electronic) quantities within the computer system memories or registers or other such information storage, transmission, or display devices.

Certain aspects of the present disclosure include process steps and instructions described herein in the form of an algorithm. It should be noted that the process steps and instructions of the present disclosure could be embodied in software, firmware, and/or hardware, and, when embodied in software, it can be downloaded to reside on, and operated from, different platforms used by a variety of operating systems.

The algorithms and displays presented herein are not inherently related to any particular computer, virtualized system, or other apparatus. Various general-purpose systems may also be used with programs, in accordance with the teachings herein, or the systems may prove convenient to construct more specialized apparatus needed to perform the required method steps. The required structure for a variety of these systems will be apparent from the description provided herein. In addition, the present disclosure is not described with reference to any particular programming language. It will be appreciated that a variety of programming languages may be used to implement the teachings of the present disclosure as described herein, and any references above to specific languages are provided for disclosure of enablement and best mode of the present disclosure.

In various embodiments, the present disclosure can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the disclosure include a mobile phone, personal digital assistant, smartphone, kiosk, desktop computer, laptop computer, consumer electronic device, television, set-top box, or the like. An electronic device for implementing the present disclosure may use an operating system such as, for example, iOS available from Apple Inc. of Cupertino, Calif., Android available from Google Inc. of Mountain View, Calif., Microsoft Windows 10 available from Microsoft Corporation of Redmond, Wash., or any other operating system that is adapted for use on the device. In some embodiments, the electronic device for implementing the present disclosure includes functionality for communication over one or more networks, including for example a cellular telephone network, wireless network, and/or computer network such as the Internet.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The terms “a” or “an,” as used herein, are defined as one as or more than one. The term “plurality,” as used herein, is defined as two or as more than two. The term “another,” as used herein, is defined as at least a second or more.

An ordinary artisan should require no additional explanation in developing the methods and systems described herein but may find some possibly helpful guidance in the preparation of these methods and systems by examining standardized reference works in the relevant art.

While the disclosure has been described with respect to a limited number of embodiments, those skilled in the art, having benefit of the above description, will appreciate that other embodiments may be devised which do not depart from the scope of the present disclosure as described herein. It should be noted that the language used in the specification has been principally selected for readability and instructional purposes, and may not have been selected to delineate or circumscribe the inventive subject matter. The terms used should not be construed to limit the disclosure to the specific embodiments disclosed in the specification and the claims, but the terms should be construed to include all methods and systems that operate under the claims set forth herein below. Accordingly, the disclosure is not limited by the disclosure, but instead its scope is to be determined entirely by the following claims.

What is claimed and desired to be secured by Letters Patent of the United States is:

1. A method for automated training of deep learning based object detection system, comprising:
(a) capturing two or more images of an object from a plurality of angles by a calibrated camera system, the two or more cameras having a predetermined position between each camera and the object;
(b) generating a modelled bounding box offset and dimensions, the modelled bounding box having an approximate offset between two bounding boxes of the same object on images from two different cameras;
(c) propagating the two or more images through a neural network model, thereby producing a predicted object bounding box and class identifier for each captured image, and generating a predicted bounding box offset between bounding boxes from images of neighboring cameras;
(d) computing a loss value as a sum of:
(i) a first penalty value computed as the discrepancy between the modelled bounding box offset and a predicted bounding box offset; and
(ii) a second penalty value computed as the discrepancy between the modelled bounding box dimensions and dimensions of predicted bounding boxes from the same image in the two or more images captured by the camera system; and
(e) adjusting the plurality of neural network parameters Wi until the loss function is minimized to less than a predetermined threshold, based on an optimization algorithm and steps (c) and (d) for the loss computation with selected neural network parameters values.

2. The method of claim 1, after the adjusting step, further comprising iteratively repeating steps (a) through (e) by moving the camera system relative to the object to one or more different angles and/or one or more different distances until all or substantially all required distances and view angles are processed and the loss value is less than a predetermined threshold.

3. The method of claim 1, wherein the computing the loss value as the sum of comprises (iii) a third penalty value added if the predicted class identifier for a particular image differs from the predicted class identifier for other images or differs from expected value, provided at the configuration of the neural network model; and (iv) a fourth penalty value added if more than one object per image is predicted.

4. The method of claim 1, wherein the loss value as a sum comprises an absolute value for each difference in offset, size, and one or more penalty values added if predicted class identifiers are different or there is more than one class identifier predicted for each image.

5. The method of claim 1, wherein the discrepancy between the modelled bounding box dimensions are computed using image analysis, based on background subtraction and color based segmentation.

6. A method of claim 1, wherein the two or more cameras comprises three or more cameras, the three more cameras being grouped to stereo pairs and dependency based box loss is computed as a discrepancy between physical object coordinates, estimated using different stereo pairs, from predicted bounding boxes, the first camera being common for all the stereo pairs.

7. The method of claim 1, wherein the two or more cameras comprises three or more cameras, the three more cameras being positioned in equidistant between the two more cameras and/or aligned to each other.

8. The method of claim 1, wherein the two or more cameras comprises three or more cameras, the three more cameras being positioned not equidistant between the two more cameras and/or unaligned to each other.

9. The method of claim 1, wherein two or more cameras are capturing moving objects within an instrumented environment and dependency based box loss is computed as a discrepancy between expected bounding box offset and the offset between predicted object bounding boxes associated with neighboring in time images.

10. A system and method of claim 1, wherein the camera system further comprises a plurality of sensors and dependency based loss is extended with knowledge base rules, measuring discrepancy between predicted object box/class identifier and sensor values or other prior info about the environment and objects.

11. The method of claim 1, where the camera system moves on x-axis, y-axis, and z-axis image the object from different angles and one or more different distances.

12. A method of claim 1, wherein workspace is equipped with calibration pattern and two or more cameras are capturing the images of an object and pattern and dependency based box loss is computed as a discrepancy between physical object coordinates with respect to the pattern, estimated using homography projection between first camera plane and workspace and physical object coordinates with respect to the pattern, estimated using homography projection between second camera plane and workspace.

13. The method of claim 1, wherein the plurality of parameter values comprise a random set of parameters, or a predetermined set of parameters from a pretrained neural network.

14. The method of claim 1, prior to the capturing step, further comprising initializing a neural network with a plurality of parameter values W0.

15. The method of claim 1, wherein the set of parameter values, Wi comprises W0, W1, W2 . . . Wi, as determined by the optimizer.

16. The method of claim 1, wherein the propagating step is performed by a forward pass, the forward pass step being executed by an object detection neural network model.

17. The method of claim 1, after step (g), wherein the neural network is self-trained to detect and identify the object.

18. The method of claim 1, wherein the optimization algorithm comprises Stochastic Gradient Descent (SGD), Adaptive Moment Estimation (ADAM), Particle Filtering, or similar algorithms.

19. A method for automated training of deep learning based object detection system, comprising:
(a) capturing the three or more images of an object from a plurality of angles by a calibrated camera system having two or more cameras, the two or more cameras having a predetermined position between each camera and the object;
(b) generating a modelled bounding box offset and dimensions;
(c) propagating the two or more images through a neural network model, thereby producing an object bounding box and class identifier prediction for each captured image,
(d) computing a loss value as a sum of:
(i) a first penalty value computed as the discrepancy between physical object coordinates with respect to the first camera, computed by a first stereo pair organized from the first camera and the second camera and physical object coordinates, computed by a second stereo pair organized from the first camera and third camera, the first camera being common for the first and second stereo pairs; and
(ii) a second penalty value computed as the discrepancy between the modelled bounding box dimensions and dimensions of predicted bounding boxes from two or more images captured by the camera system;
(e) adjusting the plurality of neural network parameters Wi until the loss function becomes nearby zero or zero, based on an optimization algorithm and steps (c) and (d) for the loss computation with selected neural network parameters values; and
(f) iteratively repeating steps (a) through (e) by moving the camera system relative to the object to one or more different angles and/or one or more different distances until all or substantially all required distances and view angles are processed and the loss value is less than a predetermined threshold.

20. A system for automated training of deep learning based object detection system, comprising:
(a) a calibrated camera system having two or more cameras for capturing two or more images of an object from a plurality of angles by a calibrated camera system, the two or more cameras having a predetermined position between each camera and the object;
(b) a calibration module configured to generate a modelled bounding box offset and dimensions for any two cameras, the modelled bounding box having an approximate offset between two bounding boxes of the same object on images from two different cameras;
(c) a neural network model configured to propagate the two or more images through a neural network model, thereby producing a predicted object bounding box and class identifier for each captured image, and generating a predicted bounding box offset between bounding boxes from images of neighboring cameras;
(d) a dependency-based loss module configured to compute a loss value as a sum of:
(i) a first penalty value computed as the discrepancy between the modelled bounding box offset and a predicted bounding box offset; and
(ii) a second penalty value computed as the discrepancy between the modelled bounding box dimensions and dimensions of predicted bounding boxes from the same image in the two or more images captured by the camera system; and
(e) an optimizer configured to adjust the plurality of neural network parameters Wi until the loss function is minimized to less than a predetermined threshold, based on an optimization algorithm and steps (c) and (d) for the loss computation with selected neural network parameters values.
